(19) United States
(12) Patent Application Publication
(10) Pub. No.: US 2012/0318441 A1
(43) Pub. Date: Dec. 20, 2012

(54) METHOD FOR MAKING A CONNECTING ROD MADE OF A COMPOSITE MATERIAL COMPRISING A REINFORCED YOKE

(75) Inventors: Richard Masson, Les Loges En Josas (FR); Patrick Dunleavy, Palaiseau (FR)

(73) Assignee: MESSIER-BUGATTI-DOWTY, Velizy Villacoublay (FR)

(21) Appl. No.: 13/512,469

(22) PCT Filed: Nov. 25, 2010
(86) PCT No.: PCT/EP2010/007141

§ 371 Date: Aug. 17, 2012

(30) Foreign Application Priority Data
Nov. 30, 2009 (FR) 09 05745

(51) Int. Cl. B32B 37/02

(52) U.S. Cl. 156/148; 156/305

(57) ABSTRACT

The invention relates to a method for making a connecting rod (6) made of a composite material and including a yoke (7) for receiving a mechanical axis, said yoke (7) including two parallel arms (7a, 7b) perpendicular to the mechanical axis, wherein the method comprises the steps of: making a mandrel (11) defining a single piece sufficiently rigid for receiving fiber layers (8a-8e, 9a-9d); applying onto said mandrel (11) base fiber layers (8a-8e) and additional layers (9a-9d) interleaved between the base layers (8a-8e) at the yoke (7, 7a, 7b) in order to form an additional thickness thereon; inserting lugs (13a, 13b) extending through the intermediate layers (9a-9d) and the base layers (8a-8e); injecting resin into the base layers (8a-8e) and the intermediate layers (9a-9d) and polymerizing said resin.

The invention concerns a method for making a connecting rod made of a composite material including a main body a part of which such as one end is reinforced to withstand a mechanical stress concentration.

### BACKGROUND OF THE INVENTION

FIG. 1 shows one such connecting rod 1 which comprises a generally tubular hollow main body 2 extended at each of its ends by a double yoke 3, 4.

Each double yoke 3, 4 comprises two arms 3a, 3b, 4a and 4b all of which are constituted of a thickness of composite material greater than the nominal thickness of composite material in the rest of the connecting rod. The two arms of each yoke lie parallel to the general direction AX of the hollow main body and each arm comprises a bore in which is mounted a metal bearing.

In a method known from the patent document FR2893532, this connecting rod is fabricated from a piece of reinforcing fiber tissue cut to the shape shown in FIG. 2. This shape comprises a central portion for the hollow main body 2 and for extensions each corresponding to a double yoke arm.

The tissue used is a carbon fiber tissue of constant thickness, of 2.5 D type, i.e. comprising a plurality of superposed layers of woven fibers, which are connected to each other by connecting fibers also known as transverse fibers.

The fabrication of this connecting rod consists in folding the piece of tissue from FIG. 2 by applying a mandrel or the like to it, then injecting resin into the reinforcing fiber tissue and curing the combination to polymerize this resin.

The thickness of the yokes is increased before shaping the tissue, by cutting the connecting fibers of the base layers of the 2.5 D tissue at the level of the yokes so as to separate these base layers from each other locally.

Interleaved layers are then inserted locally between the separated base layers, which enables the thickness to be increased locally. After adding the interleaved layers, so-called transverse fibers are passed through the assembly to fasten all the layers together.

The arms of each yoke thus have a thickness significantly greater than the thickness of the rest of the connecting rod to increase the mechanical resistance that the yoke opposes to forces exerted thereon in the direction AX. These forces result from the normal load on the connecting rod when its yoke is mounted on a shaft that is not shown in the figures.

In practice, the increased thickness that can be achieved is limited by the fact that it is difficult to add more than one interleaved layer between each layer of the 2.5 D tissue used and the next. This limitation on the increased thickness that can be produced is reflected in a limitation of the mechanical strength of the yoke and thus of the connecting rod as a whole.

### OBJECT OF THE INVENTION

The object of the invention is to propose a solution for further increasing the mechanical strength of a portion of the connecting rod.

### SUMMARY OF THE INVENTION

To this end, the invention provides a method for fabrication of a composite material connecting rod comprising a yoke adapted to receive a mechanical shaft, this yoke comprising two parallel arms perpendicular to the orientation of the mechanical shaft, the method comprising the steps of:
fabricating a mandrel forming a whole sufficiently rigid to receive layers of fibers;
applying to this mandrel base layers of reinforcing fibers constituting the connecting rod and additional layers interleaved between the base layers at the level of the yoke to constitute increased thicknesses there;
at the level of each arm of the yoke, inserting lugs passing through the interleaved layers and the base layers according to the orientation of the mechanical shaft on which this yoke is to be mounted;
injecting resin into the base layers and into the interleaved layers and polymerizing that resin.

With this solution, it appears that the lugs oriented parallel to the mechanical shaft on which the yoke is to be mounted increases the mechanical strength of the yoke vis a vis a force oriented longitudinally.

The invention also provides a method as defined above wherein the base layers are layers of reinforcing fibers braided around the mandrel and wherein each interleaved layer is formed by a reinforcing fiber binding wound around the mandrel and the base layer or layers that it carries.

The invention also provides a method as defined above wherein the binding used for the interleaved layers is a reinforcing fiber tissue tape.

The invention also provides a method as defined above wherein the lugs that are inserted are carried by a vibrating support.

The invention also provides a method as defined above wherein the vibrating support comprises a base plate one face of which carries studs and wherein a compressible material spacer having a thickness greater than the length of these studs is attached against the face carrying the studs, having these studs pass partly through it, and wherein each lug is carried by the vibrating support, being inserted in the spacer facing a corresponding stud.

### BRIEF DESCRIPTION OF THE FIGURES

FIG. 1, already described, is a general view of a known composite material connecting rod with two double yokes;

FIG. 2 already described is a view of the piece of reinforcing fiber tissue used to fabricate the connecting rod from FIG. 1 by a known method when flattened out;

FIG. 3 shows a yoke of a connecting rod produced by the method of the invention in perspective and on a section plane passing through its longitudinal axis;

FIG. 4 shows a yoke of a connecting rod produced by the method of the invention in lateral view on a section plane passing through its longitudinal axis;

FIG. 5 is a perspective view of a mandrel that may be used to fabricate a connecting rod using the method of the invention;

FIG. 6 is a perspective view showing diagrammatically an operation of depositing a braided layer of reinforcing fibers around the mandrel from FIG. 5;

FIG. 7 is a perspective view showing diagrammatically an operation of winding a layer of reinforcing fibers around a mandrel carrying a layer of braided reinforcing fibers;

FIGS. 8 to 14 show steps of an operation of insertion of lugs into a yoke arm of the invention.

### DETAILED DESCRIPTION OF THE INVENTION

The invention lies in the realization that the mechanical shaft on which the yoke is mounted exerts thereon forces oriented along the longitudinal axis of the connecting rod but that give rise in the arms of the yoke to stresses oriented perpendicularly to this longitudinal direction, which begins deterioration of the yoke by delamination when the assembly is under load.

According to the invention, the strength of the arms of each yoke is increased by reinforcing the connections fastening together the parallel layers constituting each arm, instead of increasing the increased thickness constituting those arms.

In concrete terms, when the connecting rod is under load, it is subjected to a longitudinal loading that is reflected in the connecting rod body by a mechanical stress oriented primarily in the longitudinal direction. At the level of the yokes, the forces transmitted by each shaft are to the contrary reflected in multidirectional stresses distributed heterogeneously in each arm.

These multidirectional stresses tend notably to delaminate the layers constituting each yoke arm, and so adding transverse lugs enables the cohesion between these layers to be increased, which implies an increase in mechanical strength, notably in the longitudinal direction.

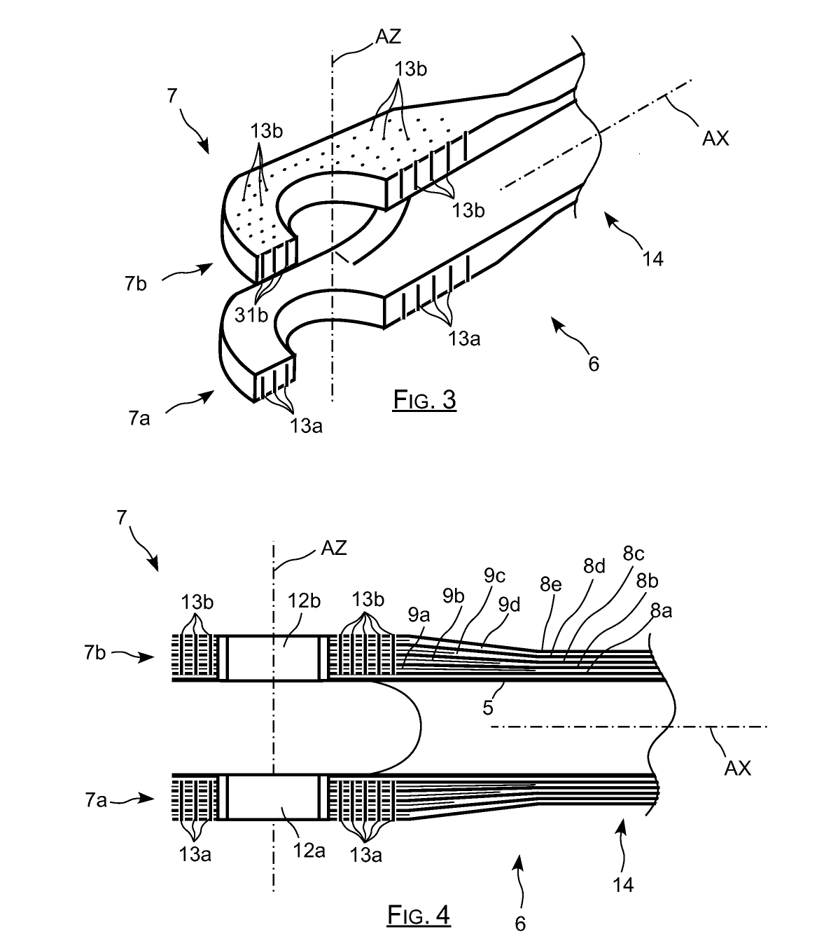

The connecting rod 6 of the invention shown in FIGS. 3 and 4 comprises a double yoke 7 constituted of two arms 7a and 7b oriented parallel to each other, extending in the longitudinal direction of the connecting rod, represented by the axis AX.

This connecting rod is constituted of an assembly of reinforcing fiber base layers 8a to 8e that surround a mandrel 11 in the form of a sleeve. At the end of this connecting rod, i.e. in the region 7 corresponding to the arms 7a and 7b, additional interleaved layers 9a to 9d have been inserted locally between the consecutive base layers 8a to 8e.

Each arm 7a, 7b is constituted of a thickness of reinforcing fibers corresponding to substantially twice the nominal thickness of the reinforcing fibers constituting the connecting rod 6, notably in its central region, i.e. in the tubular body.

Each arm 7a, 7b further comprises a bore (no reference number) in which is engaged a corresponding metal ring. These rings 12a and 12b constitute bearings aligned with an axis AZ normal to the axis AX and surround the mechanical shaft on which the yoke is to be mounted, to distribute in the arms the forces exerted by this mechanical shaft.

The reinforcing carbon fiber layers 8a-8e and 9a-9d that are superposed to constitute each arm 7a and 7b, lying in planes normal to the axis AZ, have carbon lugs passed through them that are parallel to the direction AZ and fasten the superposed layers together.

As may be seen in the figures, lugs 13a pass through the fibers layers of the arm 7a and lugs 13b pass through the fiber layers of the arm 7b.

These lugs 13a and 13b are mounted by inserting them into the reinforcing fiber layers when they are dry, i.e. before the injection of resin. The lugs are advantageously inserted into a yoke arm using a vibrating support carrying the lugs to be inserted that is moved progressively toward the external face of the yoke arm in which the lugs are inserted, as described in detail hereinafter. The lugs may also be inserted by other known methods, generally known as “z-pinning” methods. A lug density of the order of 3 to 5 lugs per square centimeter is generally employed.

Once the lugs 13a and 13b have been inserted, the assembly constituted by the mandrel 11 with the fiber base layers 8a-8e that it carries, the additional layers 9a-9d interleaved between these base layers at the level of the arms 7a and 7b, and the lugs 13a and 13b, is installed in a mold. Resin is then injected into all the layers, and this resin is polymerized by heating.

In the finished part, the connection between the base layers 8a-8e and the interleaved layers 9a-9d is provided conjointly by the polymerized resin and by the lugs.

The lugs 13a and 13b oppose delamination of the reinforcing fiber layers by contributing resistant to traction in the direction AZ, while the polymerized resin transfers the forces from one layer to another, providing shear strength in directions parallel to a plane normal to the axis AZ.

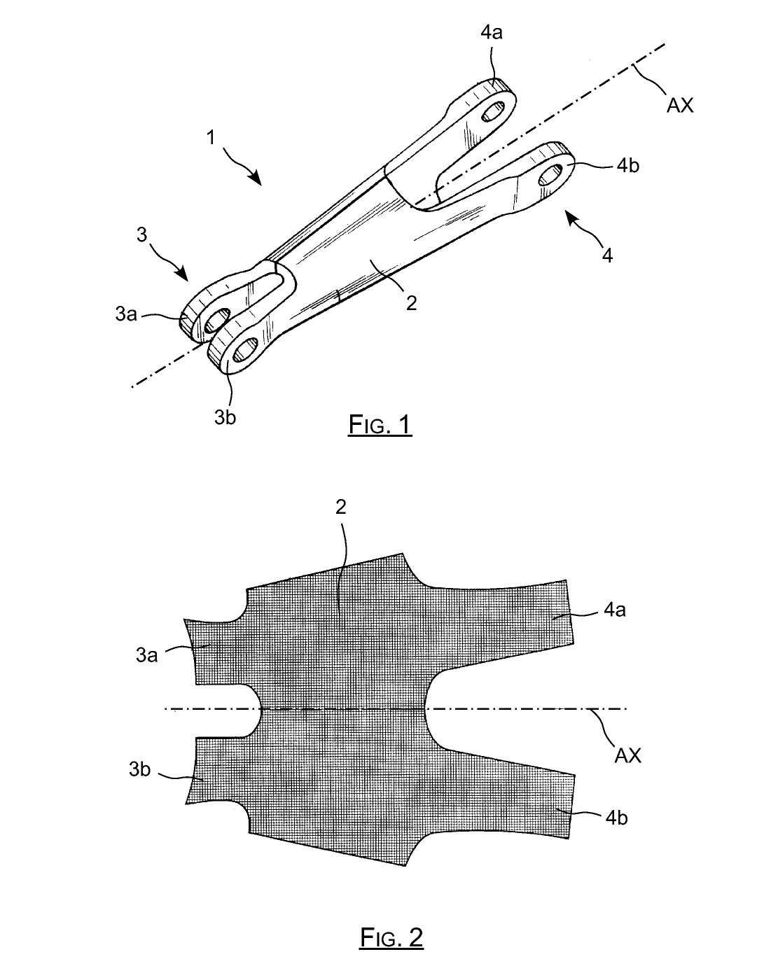

The connecting rod that is shown in FIGS. 3 and 4 may be fabricated by the method described with reference to FIGS. 1 and 2, i.e. using a piece of 2.5 D carbon reinforcing fiber tissue.

As indicated above, the transverse fibers connecting the base layers of this tissue are cut in the regions corresponding to the arms of the yokes, and additional interleaved layers are disposed between the base layers separated locally at the level of the arms.

The piece of tissue modified in this way is then installed on a mandrel with a view to the insertion of the lugs at the level of the arms of the yokes, after which the whole is then installed in a mold for injection and polymerization of resin.

The connecting rod may also advantageously be fabricated by a method in which the base layers that constitute it, namely the layers 8a-8e, are produced by braiding around the mandrel, and wherein the additional layers interleaved at the level of each yoke arm are applied by winding on woven reinforcing fiber tapes.

In this case, the lugs 13a and 13b are applied locally at the level of the yoke arms, in the direction AZ, to connect the base layers 8a-8e, which are then braided layers, to the interleaved layers 9a-9d, which are then wound layers.

As may be seen in FIG. 5, the mandrel 11 extends along the longitudinal axis AX, taking the form of a generally hollow sleeve having a general shape of revolution about this axis. The cross section of the mandrel 11 is more or less circular in the central region 14 while at the first and second ends 16, 17 this section is of substantially rectangular shape.

Two rods 18 and 19 are rigidly fastened to the ends 16 and 17 of the mandrel 11, extending in the direction AX, to enable the mandrel to be manipulated without having to hold it by its external face.

This mandrel 11, which serves to support the layers of reinforcing fibers and to impart the internal shape to the finished part, may be fabricated from layers of pre-impregnated carbon fiber tissue, the whole then being pre-polymerized to impart to it the required mechanical stiffness.

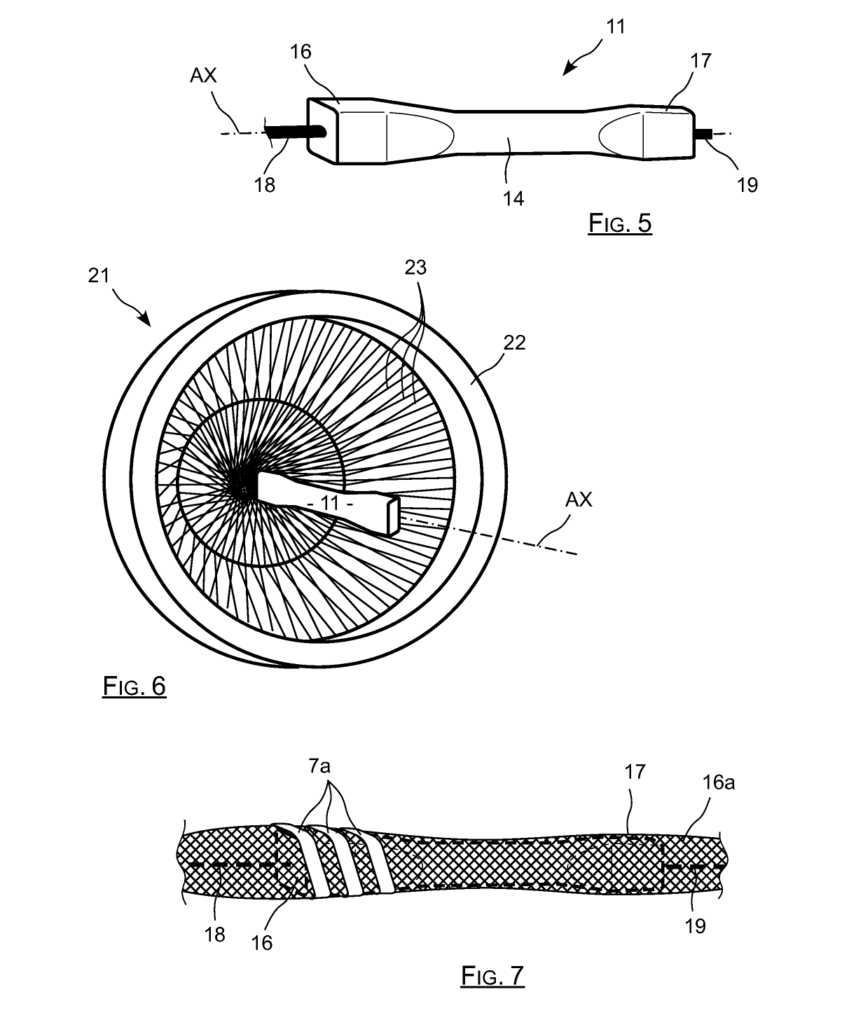

As shown in FIG. 6, once the mandrel 11 has been completed, it is engaged in a braiding machine 21 in order to braid around it a first base layer 8a of reinforcing carbon fibers. This machine 21 primarily comprises a ring 22 centered on the axis AX and carrying a series of spools of carbon fibers 23.

When the mandrel 11 is moved by control means along the axis AX through the ring 22, a carbon fiber “sock” is woven around the external face of the mandrel 11. As may be seen in FIG. 7, the first braided carbon fiber base layer 8a surrounds the mandrel 11 over the whole of its length and extends beyond its ends 16 and 17.

When this first braided layer 8a has been applied, a first tape 9a is wound around the first end 16 of the mandrel 11, over this first base layer 8a, to constitute a locally increased thickness reinforcing the arms of the double yoke 7.

The first end of the connecting rod coincides with the first end 16 of the mandrel 11, the central region of the connecting rod coincides with the central region 14 of the mandrel 11, and the second end of the connecting rod coincides with the second end 17 of the mandrel 11.

The wound tape 9a is disposed in accordance with a helicoidal general shape with a substantially rectangular base, conforming to the section of the end of the mandrel 11 it surrounds. In FIG. 7, the tape 9a surrounds the end 16 over three helicoidal turns that are spaced from each other.

On the one hand, the helicoidal turns may also be contiguous instead of being spaced from each other and, on the other hand, a plurality of layers of tape may be wound successively around this first end, in such a manner as to add to the increased thickness introduced in this way between two braided layers.

This tape may be applied manually, automatically or semi-automatically. For example, this winding may be affected by a winding machine comprising a ring surrounding the mandrel 11, adapted to turn around the latter, and carrying a spool of reinforcing fiber tape. Rotation of the ring and forward movement of the mandrel along the axis AX enable winding to be carried out with a pitch that is adjustable as required.

Once this first tape 9a has been wound around the first end, the whole of the mandrel 11 with the first braided base layer 8a and the first wound tape 9a is again offered up inside the ring 22 to braid another base layer 8b of reinforcing fibers around this assembly.

Once this second base layer 8b has been braided, a second tape is wound around the first end 16, and operations of application of braided layers and of wound tapes are carried out successively up to application of the last braided base layer.

When all the layers have been applied, the lugs are inserted at the level of each yoke arm to increase the mechanical strength of the connections that connect together the braided base layers and the wound interleaved layers.

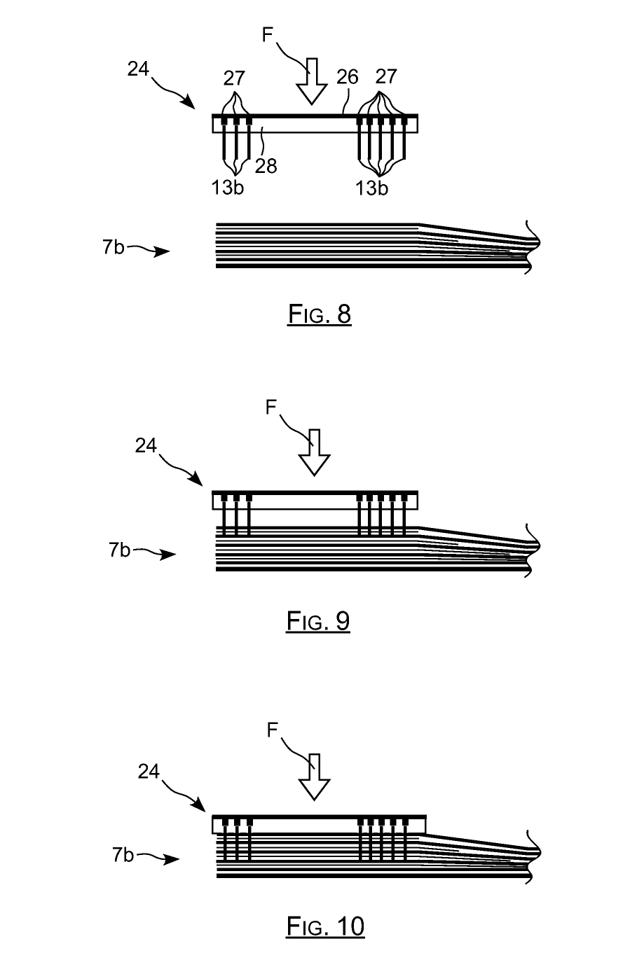

As shown diagrammatically in FIGS. 8 to 14, the lugs are inserted in the yoke arm 7b using a vibrating support that carries the lugs 13b and that is lowered towards the external face of the arm 7b. Lugs are inserted into the other arm 7a in an analogous manner.

The vibrating support 24 includes a base plate 26 equipped with a set of studs 27 or the like projecting from one of its faces and each situated at the location of a lug to be inserted.

A spacer 28 of polypropylene, polystyrene or like material having a thickness greater than the length of these studs 27 is applied to the face carrying these studs so as to bear against the corresponding face of the base plate 26 and to have the studs 27 pass partially through it.

Each lug 13b to be inserted in the yoke arm 7b is first “planted” in the free face of the spacer 28, facing a corresponding stud 27, so that its end bears against the end of that stud 27. Generally speaking, the spacer is fabricated in a material sufficiently flexible for on the one hand the studs 27 and on the other hand the lugs 13b to pass through it.

At this stage, and as shown diagrammatically in FIG. 8, the vibrating support 24 that carries the lugs 13b that have not yet been inserted is positioned above the external face of the yoke arm 7b. The means for vibrating this vibrating support are then activated, at the same time as the whole is lowered toward the yoke arm, being subjected to a force shown by the arrow F in the drawings.

As the vibrating support is lowered, the lugs 13b that it carries are engaged through the base layers and the interleaved layers constituting the arm 7b, as shown in FIG. 9, until the spacer 28 comes into contact with the external face of this arm 7b, which corresponds to the situation shown in FIG. 10.

As the spacer 28 is fabricated from a flexible and/or compressible material, the downward movement of the vibrating support 24 may nevertheless continue, because of the effect of the force F, which compresses the spacer 28, thereby reducing its thickness.

At this stage, which is shown diagrammatically in FIG. 11, the rigid studs 27 partially penetrate the first layers of fiber via the external face of the arm 7b. The ends of the lugs 13b are then embedded in the arm 7b, instead of projecting from its external face.

In other words, the use of a vibrating support 24 equipped with a compressible material spacer 28 enables complete embedding of the lugs 13b within the thickness of the yoke arm 7b, as shown diagrammatically in FIG. 12.

The fact that the lugs 13b are embedded within the thickness of the arm facilitates installation of the assembly formed by the mandrel and the layers that it is carrying into the mold in order to inject and polymerize the resin for bonding the assembly.

In practice, the reinforcing fiber layers constituting the connecting rod have some compressibility in the radial direction, and these layers are compressed upon installation in the mold, which further increases the density of the fibers throughout the part.

Because the lugs 13b are completely embedded within the thickness of the reinforcing fiber layers, they do not constitute an obstacle to radial compression of these fiber layers after the assembly is installed in the injection mold.

As shown diagrammatically in FIGS. 12 and 13, the yoke arm 7b has a thickness e before installation in the mold and its thickness decreases to the value e′ after installation in the mold.

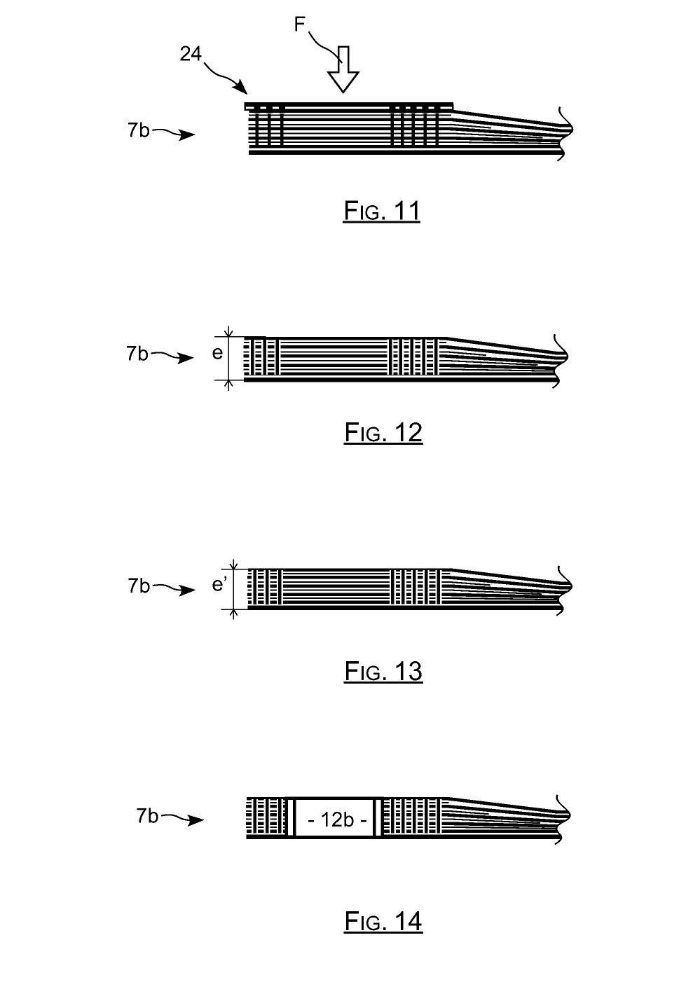

Once the resin has been injected and polymerized, the double yoke is machined, and the bore may be produced in each yoke arm, for mounting the corresponding ring therein, as shown diagrammatically in FIG. 14.

The double yoke 7 may be machined for example by passing a metal slitting saw across the first end of the raw part, in a plane containing the axis AX and oriented in a direction normal to the axis AZ.

The pass of this metal slitting saw forms a groove that separates the two arms or branches 7a and 7b of the double yoke 7 from each other, so that they are spaced by a distance corresponding to the thickness of the metal slitting saw.

In the examples of FIGS. 5 to 7, the material that is wound around the first end is a reinforcing fiber binding taking the form of a woven fiber tape. It is also possible to wind directly the reinforcing fiber, a ribbon, a wick or a strand made up of reinforcing fibers. More generally, it is a matter of winding a binding fabricated from reinforcing fibers that are advantageously fibers of the same kind as the fibers of the base layers.

Moreover, in the example shown in the figures, the method is used to reinforce one connecting rod end. The invention may find other applications, however: it is possible to wind one or more tapes in a central region of the connecting rod body, for example, and to reinforce them by means of lugs.

1. A method for fabrication of a composite material connecting rod (6) comprising a yoke (7) adapted to receive a mechanical shaft, this yoke (7) comprising two parallel arms (7a, 7b) perpendicular to the orientation (AZ) of the mechanical shaft, the method comprising the steps of:
fabricating a mandrel (11) forming a whole sufficiently rigid to receive layers of fibers (8a-8e, 9a-9d);
applying to this mandrel (11) base layers (8a-8e) of reinforcing fibers constituting the connecting rod (6) and additional layers (9a-9d) interleaved between the base layers (8a-8e) at the level of the yoke (7, 7a, 7b) to constitute increased thicknesses there;
at the level of each arm (7a, 7b) of the yoke (7), inserting lugs (13a, 13b) passing through the interleaved layers (9a-9d) and the base layers (8a-8e) according to the orientation (AZ) of the mechanical shaft on which this yoke (7) is to be mounted;
injecting resin into the base layers (8a-8e) and into the interleaved layers (9a-9d) and polymerizing that resin.

2. The method claimed in claim 1, wherein the base layers (8a-8e) are layers of reinforcing fibers braided around the mandrel (11) and wherein each interleaved layer (9a-9b) is formed by a reinforcing fiber binding wound around the mandrel (11) and the base layer or layers (8a-8b) that it carries.

3. The method claimed in claim 2, wherein the binding used for the interleaved layers (9a-9b) is a reinforcing fiber tissue tape.

4. The method claimed in claim 1, wherein the lugs (13a, 13b) that are inserted are carried by a vibrating support (24).

5. The method claimed in claim 4, wherein the vibrating support (24) comprises a base plate (26) one face of which carries studs (27) and wherein a compressible material spacer (28) having a thickness greater than the length of these studs (27) is attached against the face carrying the studs (27), having these studs (27) pass partly through it, and wherein each lug is carried by the vibrating support (24), being inserted in the spacer (26) facing a corresponding stud (27).
